(19) United States
(12) Patent Application Publication
(10) Pub. No.: US 2019/0083831 A1
(43) Pub. Date: Mar. 21, 2019

(54) FIREHOSE CARRYING DEVICE

(71) Applicants: Christopher Howell Spaulding, Moreno Valley, CA (US); Barbara Ann Spaulding, Moreno Valley, CA (US)

(72) Inventors: Christopher Howell Spaulding, Moreno Valley, CA (US); Barbara Ann Spaulding, Moreno Valley, CA (US)

(21) Appl. No.: 16/122,739

(22) Filed: Sep. 5, 2018

Related U.S. Application Data
(60) Provisional application No. 62/561,510, filed on Sep. 21, 2017.

(51) Int. Cl. A62C 33/04; A62C 99/00

(52) U.S. Cl. CPC A62C 33/04; A62C 99/0081

(57) ABSTRACT

A device for holding a rolled fire hose is disclosed herein. The device includes a clamp hinge, a first clamp half and a second clamp half. The device eases the process of transporting and storing a fire hose or any other hose that needs to be gathered and kept in place during transport or storage. It prevents hoses from becoming entangled with other equipment and eliminates wasted man hours spent sorting and untangling. Further, it reduces the amount of time required to store and organize hoses in a warehouse, decreasing wasted labor hours, allowing for quicker, cleaner, and faster transportation and storage of hoses

### CROSS REFERENCE TO RELATED APPLICATION

The present application is related to and claims priority to U.S. Provisional Patent Application No. 62/561,510 filed Sep. 21, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of clamps and more specifically relates to hosepipe clamps and carriers.

### 2. Description of Related Art

The tasks of transporting and storing a fire hose are time consuming and laborious for the worker. Presently, there is not an efficient method for transporting a fire hose and the current method involves the worker having to clutch the hose to their stomach, hoist the hose over their shoulder, or try to force their fingers into the hose to get a grip. This method often results in dirty clothes, tired workers, and wasted man-hours. Keeping the fire hoses properly stored and organized is also difficult. Too often, the hoses become tangled with other equipment and require sorting before storage.

U.S. Pat. No. 5,979,840 to Ronald S. Hollister relates to an apparatus for gripping a fluid carrying hose. The described apparatus for gripping a fluid carrying hose includes a jaw sized for placement about a pressurized hose, the jaw having a first end portion and a second end portion distal and generally opposite to the first end portion, a handgrip pivotally attached to the first end portion of the jaw, the handle having a normal position, and a plunger movably secured in the first end portion of the jaw. The plunger has a first end for contacting a portion of the handgrip and a second end opposite the first end of the plunger for grasping the surface of the pressurized hose. The plunger is responsive to the movement of the handgrip wherein the plunger moves in a first direction toward the second end portion of the jaw as the handgrip is pivoted in one direction and wherein the plunger moves in a second direction away from the second end portion of the jaw as the handgrip is moved back to the normal position.

### BRIEF SUMMARY OF THE INVENTION

In view of the foregoing disadvantages inherent in the known clamps art, the present disclosure provides a novel firehose carrying device. The general purpose of the present disclosure, which will be described subsequently in greater detail, is to provide a device to ease a process of transporting and storing a fire hose or any other hose that needs to be gathered and kept in place during transport or storage. It may prevent hoses from becoming entangled with other equipment and eliminates wasted man hours spent sorting and untangling. It may further reduce the amount of time required to store and organize hoses in a warehouse, decreasing wasted labor hours. The present device may allow for quicker, cleaner, and faster transportation and storage of hoses.

A device for holding a rolled fire hose is disclosed herein. The device includes a clamp hinge, a first clamp half, and a second clamp half. The clamp hinge has a pivot axis, said pivot axis defining a hinge plane, said hinge plane defining a first side and a second side opposite the first side, the pivot axis being perpendicular to the roll axis when the device is holding the rolled fire hose, the hinge plane being normal to the roll axis when the device is holding the rolled fire hose. The first clamp half is coupled to the clamp hinge, and together sized and dimensioned for clamping and carrying the rolled fire hose, the first clamp half includes a first handle half and a first clamp jaw, said first handle half positioned on the first side of the hinge plane and said first clamp jaw positioned on the second side of the hinge plane. The second clamp half is pivotably-coupled to the first clamp half via the clamp hinge, the second clamp half is sized and dimensioned for clamping and carrying the rolled fire hose. Also, the second clamp half includes a second handle half and a second clamp jaw, said second handle half positioned on the second side of the hinge plane and said second clamp jaw positioned on the first side of the hinge plane.

A method for holding a rolled fire hose is also disclosed herein. The method includes the steps of: providing the device as described above; squeezing the first handle half and the second handle half to manipulate the first clamp jaw and the second clamp jaw; clamping the first clamp jaw and the second clamp jaw onto the rolled fire-hose; and carrying the rolled fire-hose via the first handle half and the second handle half.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a firehose carrying device, constructed and operative according to the teachings of the present disclosure.

FIG. 1 is a side view of a device for holding a rolled fire hose during an ‘in-use’ condition, according to an embodiment of the disclosure.

FIG. 2 is a perspective view of the device of FIG. 1, according to an embodiment of the present disclosure.

FIG. 3A is a perspective view of the device of FIG. 1, according to an embodiment of the present disclosure.

FIG. 3B is a perspective view of the device of FIG. 1, according to an embodiment of the present disclosure.

FIG. 4 is a perspective view of the device of FIG. 1, according to an embodiment of the present disclosure.

FIG. 5 is a flow diagram illustrating a method of use for device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to clamps and more particularly to a firehose carrying device as used to improve the hosepipe clamps and carriers.

Generally disclosed is a device designed to assist users in storing and transporting fire hoses or any other type of hose that needs to be gathered and kept in place. The device may include a fire hose-gripping device for moving and storing a fire hose in a clean manner. The device may be made from a rigid material and may include two handles, a hinge, and a clamping portion. The device may use a hinge to pivotably clamp a flat, rolled fire hose between twin recesses on the distal end of the apparatus. The clamping portion may be configured to clamp all, just a few, or only one of the rings of a rolled hose. The clamp may have a spring-actuated lock, which may engage when clamped around the rolled hose. Once clamped, the device may form an attached handle that allows for easy transport. The exact specifications may vary.

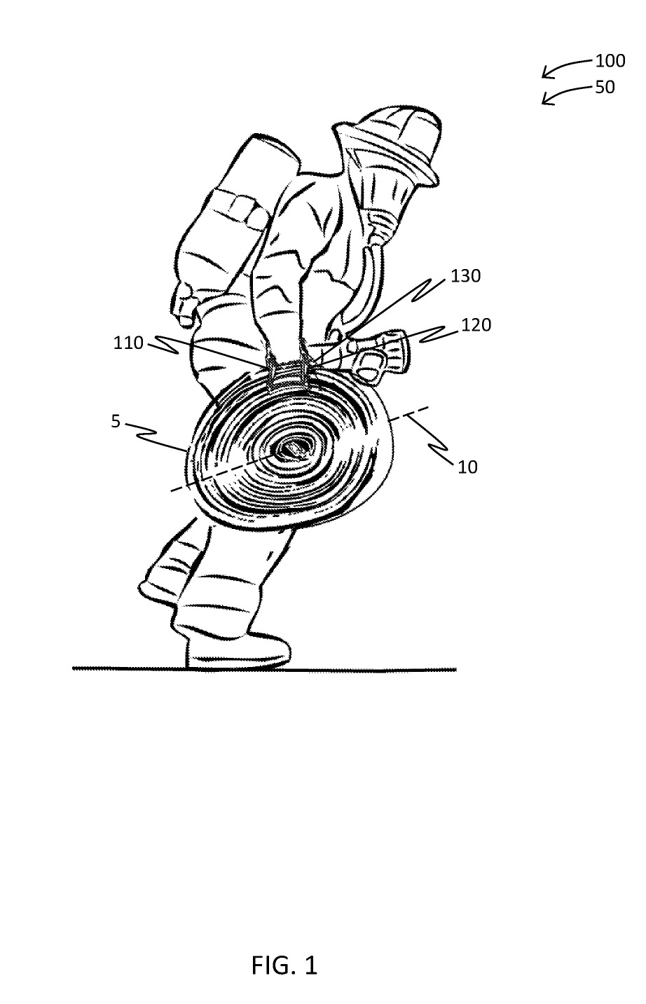

Referring now more specifically to the drawings by numerals of reference, there is shown in FIGS. 1-4, various views of a device 100.

FIG. 1 shows a device 100 during an ‘in-use’ condition 50, according to an embodiment of the present disclosure. As Illustrated, the device 100 may include a clamp hinge 110, a first clamp half 120, and a second clamp half 130. As shown, the device 100 may be used for holding a rolled fire hose 5, the rolled fire hose 5 defining a roll axis 10, about which the hose is rolled. The first clamp half 120 may be coupled to the clamp hinge 110, and together sized and dimensioned for clamping and carrying the rolled fire hose 5 (FIG. 1). Similarly, the second clamp half 130 may be pivotably-coupled to the first clamp half 120 via the clamp hinge 110 and sized and dimensioned for clamping and carrying the rolled fire hose 5.

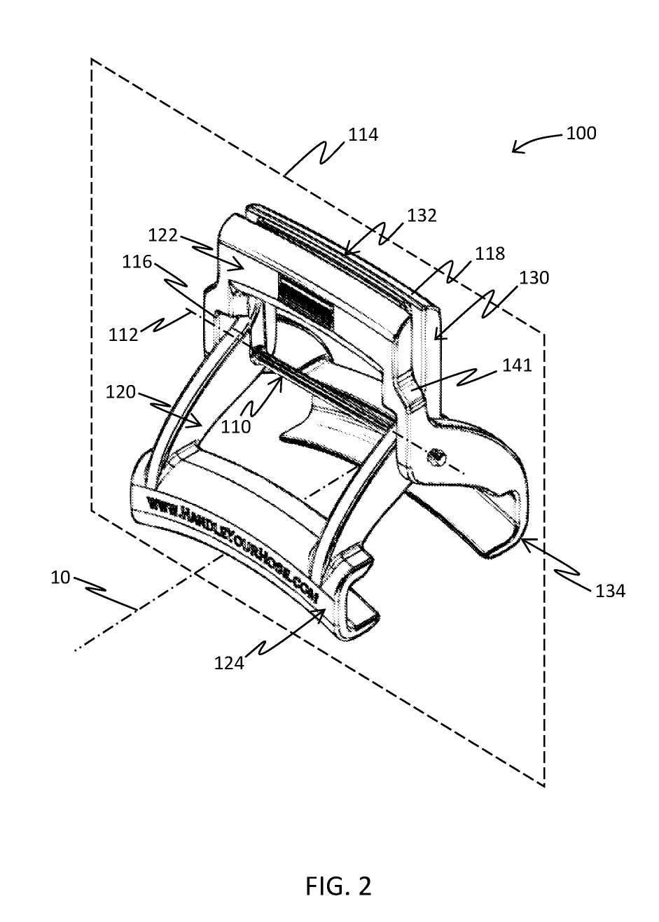

FIG. 2 is a perspective view of the device 100 of FIG. 1, according to an embodiment of the present disclosure. As above the device 100 may include the clamp hinge 110, the first clamp half 120, and the second clamp half 130. According to one embodiment, the device 100 may include a first locking-mechanism 141 that is configured to selectively lock the first clamp half 120 and the second clamp half 130 from pivoting relative to each other via the clamp hinge 110. In one embodiment, the first locking-mechanism 141 may be spring-actuated.

As shown, the clamp hinge 110 may have a pivot axis 112 defining a hinge plane 114 and the hinge plane 114 may define a first side 116 and a second side 118 opposite the first side 116. The pivot axis 112 may be perpendicular to the roll axis 10 when the device 100 is holding the rolled fire hose 5 (FIG. 1) and the hinge plane 114 may be normal to the roll axis 10 when the device 100 is holding the rolled fire hose 5.

As shown, the first clamp half 120 may include a first handle half 122 positioned on the first side 116 of the hinge plane 114, and a first clamp jaw 124 positioned on the second side 118 of the hinge plane 114. Similarly, the second clamp half 130 may include second handle half 132 positioned on the second side 118 of the hinge plane 114 and a second clamp jaw 134 positioned on the first side 116 of the hinge plane 114.

Also as shown, the first clamp half 120 and the second clamp half 130 may be pivotably coupled together via the clamp hinge 110 such that gripping the first handle half 122 together with the second handle half 132 creates an opposing clamping force by the first clamp jaw 124 and the second clamp jaw 134 against one or more loops/rings of the rolled fire hose 5 when held there between.

The first clamp jaw 124 and the second clamp jaw 134 may be together sized and dimensioned to substantially circumscribe a radial section of the rolled fire hose 5, relative to the roll axis 10. For example, the first clamp jaw 124 and the second clamp jaw 134 may dig into portions of the rolled fire hose 5 in a direction parallel with to the roll axis 10. As above, the radial section may include one, several, or all of the loops/rings of the rolled fire hose 5. Further, the first clamp jaw 124 and the second clamp jaw 134 may be configured to contact each other through the rolled fire hose 5, thus completely circumscribe the radial section of the rolled fire hose 5.

It is contemplated that the first clamp-half 120 and the second clamp-half 130 may be constructed from a rigid material such as a metal or a plastic-material of sufficient strength and hardness to prevent bending of the device 100 if carrying a heavy object, such as the rolled fire hose 5. However, other materials may be used. It is also contemplated that the plastic-material may include fire-resistant properties to render the plastic-material as inflammable as possible. Fire-resistant properties may be added to the plastic-material through the use of components such as chlorine, halogen compounds, nitrogen compounds, phosphor compounds, etc.

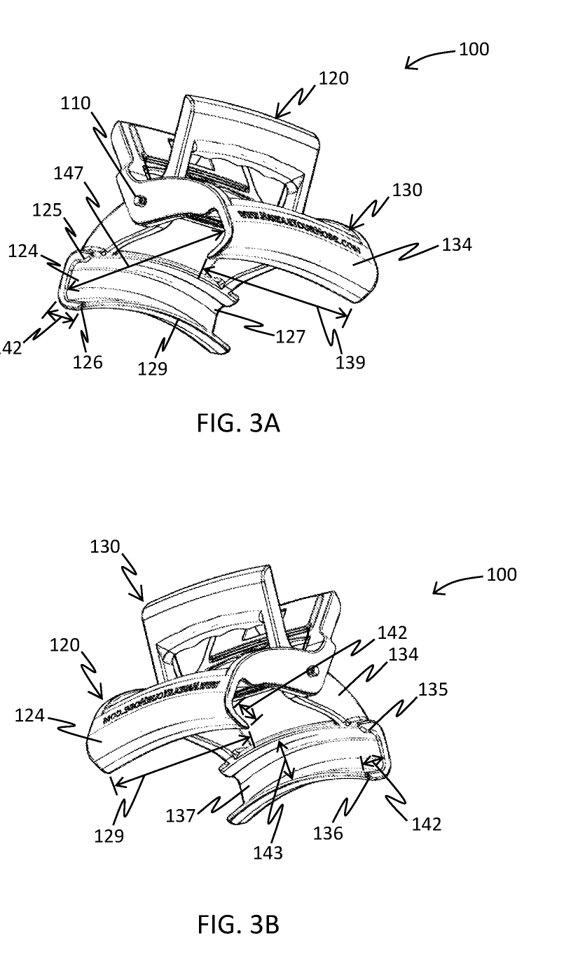

FIGS. 3A-3B are perspective views of the device 100 of FIG. 1, according to an embodiment of the present disclosure. As above the device 100 may include the clamp hinge 110, the first clamp half 120, and the second clamp half 130. Of particular interest here is the first clamp jaw 124 and the second clamp jaw 134, and the features thereof.

The first clamp jaw 124 may include a first top-lip 125, a first bottom-lip 126, and a first hose-channel 127 having a first C-shaped cross section and extending between the first top-lip 125 and the first bottom-lip 126. It should be understood that “C-shape” is used in its broadest sense as any concave shape (e.g., smooth curve, angled/rectilinear/polygon, asymmetric, or any combination thereof), and is not dependent on orientation (e.g., may include a “U-shape” or an inverted “C-shape”.

The first top-lip 125, the first bottom-lip 126, and the first hose-channel 127 together may extend a first clamp-length 129 (the first clamp-length 129 being measured parallel with the pivot axis 112 (FIG. 2)). Likewise, the second clamp jaw 134 may include a second top-lip 135, a second bottom-lip 136, and a second hose-channel 137 having a second C-shaped cross section and extending between the second top-lip 135 and the second bottom-lip 136. The second top-lip 135, the second bottom-lip 136, and the second channel, together extending a second clamp-length 139 (the second clamp-length 139 also being measured parallel with the pivot axis 112).

As shown, the first clamp jaw 124 and the second clamp jaw 134 may define a clamping-space 147 therebetween. Preferably, the clamping-space 147 may be adjustable so as to accommodate a plurality of fire hoses of different sizes. It is also contemplated that the device 100 may be used for holding and carrying apparatus other than fire hoses so it preferable that the clamping-space 147 is adjustable to allow for a variety of different applications.

In one embodiment, the first hose-channel 127 and the second hose-channel 137 may be each sized and dimensioned to have a channel-depth 142 of between 0.5-1 inches. Further to this, the first hose-channel 127 and the second hose-channel 137 may be each sized and dimensioned to have a channel-width 143 of between 1-3 inches. In addition, the first clamp-length 129 and the second clamp-length 139 may be between 4-6 inches. In one embodiment, as shown, it is contemplated that the first clamp-length 129 may be greater than the second clamp-length 139.

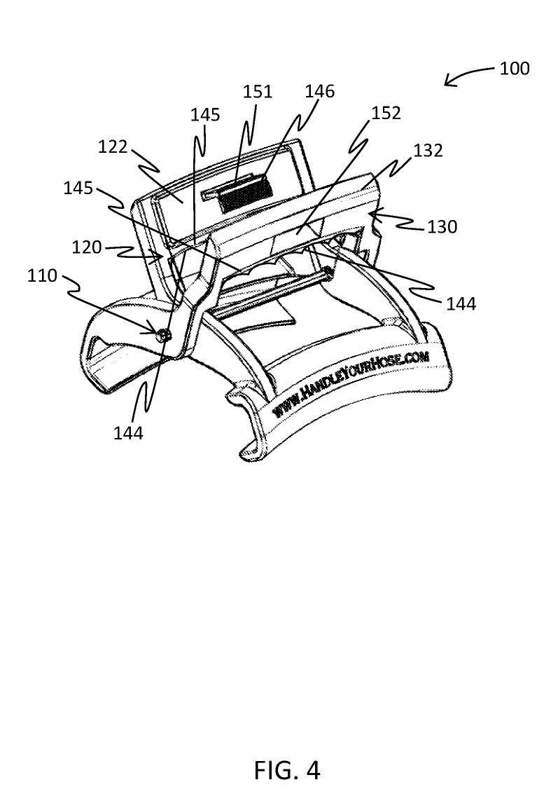

FIG. 4 is a perspective view of the device 100 of FIG. 1, according to an embodiment of the present disclosure. As above the device 100 may include the clamp hinge 110, the first clamp half 120, and the second clamp half 130. Of particular interest here is the first handle half 122 and the second handle half 132 and the features thereof.

As above, the first clamp half 120 may include the first handle half 122, and the second clamp half 130 may include a second handle half 132. As shown here, at least one of the first handle half 122 and the second handle half 132 may include a second locking-mechanism 146 configured to fixedly couple the first handle half 122 to the second handle half 132. This coupling may allow the first handle half 122 and the second handle half 132 to become one handle, thus making the carrying of the fire hose easier.

As shown, the second locking-mechanism 146 may be a slideable lock located on the first handle half 122. The slideable lock may include a protrusion 151 configured to mate with aperture 152 located in the second handle half 132. Sliding the lock may encourage the protrusion 151 into the aperture 152 to lock the first handle half 122 to the second handle half 132. In other embodiments, it should be appreciated that the slideable lock may be located on the second handle half 132, and the apertures may be located on the first handle half 122.

According to one embodiment, at least one of the first handle half 122 and the second handle half 132 may include a plurality of finger-grooves 144 configured to receive and at least partially conform to fingers of a user. Further, the first handle half 122 and the second handle half 132 may each further include a non-slip material 145 configured to aid in grip-ability. In one example, this non-slip material 145 may be a rubber material. In another example, the non-slip material 145 may be a silicone material. In other examples, the non-slip material 145 may be a hybrid of the rubber material and the silicone material.

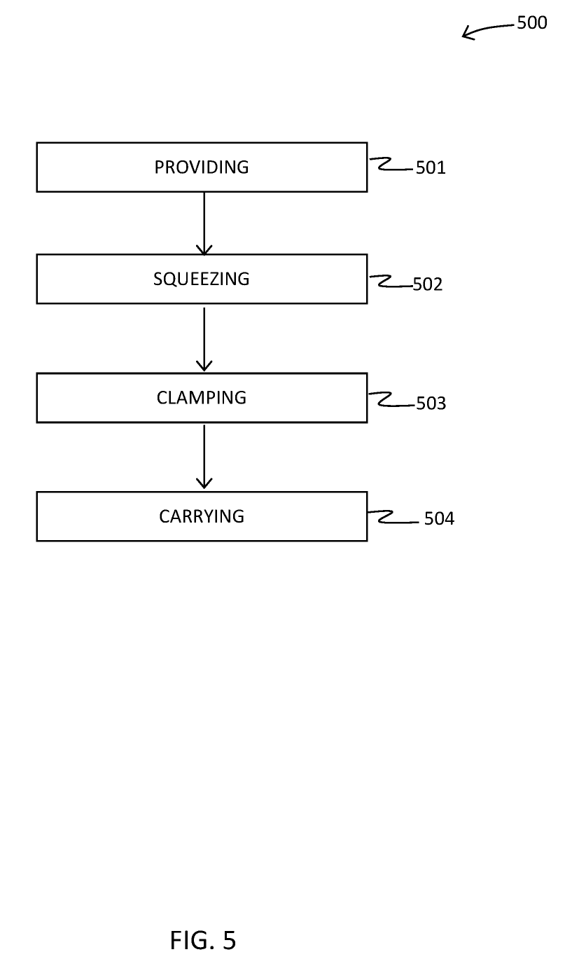

FIG. 5 is a flow diagram illustrating a method for holding a rolled fire hose, the rolled fire hose defining a roll axis 500, according to an embodiment of the present disclosure. As illustrated, the method for holding a rolled fire hose, the rolled fire hose defining a roll axis 500 may include the steps of: providing 501 the device 100 as above; squeezing 502 the first handle half 122 and the second handle half 132 to manipulate the first clamp jaw 124 and the second clamp jaw 134; clamping 503 the first clamp jaw 124 and the second clamp jaw 134 onto the rolled fire-hose 5; and carrying 504 the rolled fire-hose 5 via the first handle half 122 and the second handle half 132.

It should be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for device 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for holding a rolled fire hose, the rolled fire hose defining a roll axis, the device comprising:
a clamp hinge having a pivot axis, said pivot axis defining a hinge plane, said hinge plane defining a first side and a second side opposite the first side, the pivot axis being perpendicular to the roll axis when the device is holding the rolled fire hose, the hinge plane being normal to the roll axis when the device is holding the rolled fire hose;
a first clamp half coupled to the clamp hinge, and together sized and dimensioned for clamping and carrying the rolled fire hose, the first clamp half including a first handle half and a first clamp jaw, said first handle half positioned on the first side of the hinge plane and said first clamp jaw positioned on the second side of the hinge plane; and
a second clamp half pivotably-coupled to the first clamp half via the clamp hinge, the second clamp half sized and dimensioned for clamping and carrying the rolled fire hose, the second clamp half including a second handle half and a second clamp jaw, said second handle half positioned on the second side of the hinge plane and said second clamp jaw positioned on the first side of the hinge plane.

2. The device of claim 1, further comprising a first locking-mechanism configured to selectively lock the first clamp half and the second clamp half from pivoting relative to each other via the clamp hinge.

3. The device of claim 2, wherein the first locking-mechanism is spring-actuated.

4. The device of claim 1, wherein the first clamp jaw includes a first top-lip, a first bottom-lip, and a first hose-channel having a first C-shaped cross section and extending between the first top-lip and the first bottom-lip, the first top-lip, the first bottom-lip, and the first hose-channel together extending a first clamp-length, said first clamp length measured parallel with the pivot axis; and
wherein the second clamp jaw includes a second top-lip, a second bottom-lip, and a second hose-channel having a second C-shaped cross section and extending between the second top-lip and the second bottom-lip, the second top-lip, the second bottom-lip, and the second hose-channel, together extending a second clamp-length.

5. The device of claim 4, wherein the first clamp jaw and the second clamp jaw are together sized and dimensioned to substantially circumscribe a radial section of the rolled fire hose, relative to the roll axis.

6. The device of claim 6, wherein the first hose-channel and the second hose-channel are each sized and dimensioned to have a channel-depth of between 0.5-1 inches.

7. The device of claim 8, wherein the first hose-channel and the second hose-channel are each sized and dimensioned to have a channel-width of between 1-3 inches.

8. The device of claim 4, wherein the first clamp-length is between 4-6 inches.

9. The device of claim 4, wherein the second clamp-length is between 4-6 inches.

10. The device of claim 4, wherein the first clamp-length is greater than the second clamp-length.

11. The device of claim 1, wherein the first handle half and the second handle half each include a plurality of finger-grooves configured to receive and at least partially conform to fingers of a user.

12. The device of claim 11, wherein the first handle half and the second handle half each further include a non-slip material configured to aid in grip-ability.

13. The device of claim 12, wherein the non-slip material is a rubber material.

14. The device of claim 12, wherein the non-slip material is a silicone material.

15. The device of claim 1, wherein at least one of the first handle half and the second handle half includes a second locking-mechanism configured to fixedly couple the first handle half to the second handle half.

16. The device of claim 1, wherein the first clamp jaw and the second clamp jaw define a clamping-space therebetween; and
wherein said clamping-space is adjustable so as to accommodate a plurality of fire hoses of different sizes and lengths.

17. The device of claim 1, wherein the first clamp-half and the second clamp-half are constructed from a plastic-material.

18. The device of claim 17, wherein the plastic-material has fire-resistant properties.

19. A device for holding a rolled fire hose, the rolled fire hose defining a roll axis, the device comprising:
a clamp hinge having a pivot axis, said pivot axis defining a hinge plane, said hinge plane defining a first side and a second side opposite the first side, the pivot axis being perpendicular to the roll axis when the device is holding the rolled fire hose, the hinge plane being normal to the roll axis when the device is holding the rolled fire hose;
a first clamp half coupled to the clamp hinge, and together sized and dimensioned for clamping and carrying the rolled fire hose, the first clamp half including a first handle half and a first clamp jaw, said first handle half positioned on the first side of the hinge plane and said first clamp jaw positioned on the second side of the hinge plane;
a second clamp half pivotably-coupled to the first clamp half via the clamp hinge, the second clamp half sized and dimensioned for clamping and carrying the rolled fire hose, the second clamp half including a second handle half and a second clamp jaw, said second handle half positioned on the second side of the hinge plane and said second clamp jaw positioned on the first side of the hinge plane; and
a first locking-mechanism configured to selectively lock the first clamp half and the second clamp half from pivoting relative to each other via the clamp hinge; and
wherein the first locking-mechanism is spring-actuated;
wherein the first clamp jaw includes a first top-lip, a first bottom-lip, and a first hose-channel having a first C-shaped cross section and extending between the first top-lip and the first bottom-lip, the first top-lip, the first bottom-lip, and the first channel together extending a first clamp-length, said first clamp length measured parallel with the pivot axis;
wherein the second clamp jaw includes a second top-lip, a second bottom-lip, and a second hose-channel having a second C-shaped cross section and extending between the second top-lip and the second bottom-lip, the second top-lip, the second bottom-lip, and the second channel, together extending a second clamp-length;
wherein the first clamp jaw and the second clamp jaw are together sized and dimensioned to substantially circumscribe a radial section of the rolled fire hose, relative to the roll axis;
wherein the first clamp-length is greater than the second clamp-length;
wherein the first handle half and the second handle half each include a plurality of finger-grooves configured to receive and at least partially conform to fingers of a user;
wherein the first handle half and the second handle half each further include a non-slip material configured to aid in grip-ability;
wherein at least one of the first handle half and the second handle half includes a second locking-mechanism configured to fixedly couple the first handle half to the second handle half;
wherein the first clamp jaw and the second clamp jaw define a clamping-space therebetween; and
wherein said clamping-space is adjustable so as to accommodate a plurality of fire hoses of different sizes and lengths.

20. A method for holding a rolled fire hose, the rolled fire hose defining a roll axis, the method comprising the steps of:
providing a device for holding the rolled fire hose, the device including:
a clamp hinge having a pivot axis, said pivot axis defining a hinge plane, said hinge plane defining a first side and a second side opposite the first side, the pivot axis being perpendicular to the roll axis when the device is holding the rolled fire hose, the hinge plane being normal to the to the roll axis when the device is holding the rolled fire hose,
a first clamp half coupled to the clamp hinge, and together sized and dimensioned to clamp and carry the rolled fire hose, the first clamp half including a first handle half and a first clamp jaw, said first handle half positioned on the first side of the hinge plane and said first clamp jaw positioned on the second side of the hinge plane, and
a second clamp half pivotably-coupled to the first clamp half via the clamp hinge, the second clamp half sized and dimensioned to clamp and carry the rolled fire hose, the second clamp half including a second handle half and a second clamp jaw, said second handle half positioned on the second side of the hinge plane and said second clamp jaw positioned on the first side of the hinge plane;
squeezing the first handle half and the second handle half to manipulate the first clamp jaw and the second clamp jaw;
clamping the first clamp jaw and the second clamp jaw onto the rolled fire-hose; and
carrying the rolled fire-hose via the first handle half and the second handle half.
